(19) United States
(12) Patent Application Publication
(10) Pub. No.: US 2007/0211182 A1
(43) Pub. Date: Sep. 13, 2007

(54) Optical system thermal management methods and systems

(75) Inventors: Alexei A. Erchak, Cambridge, MA (US); Elefterios Lidorikis, Ioannina (GR); Alexander L. Pokrovskiy, Burlington, MA (US); Robert F. Karlicek JR., Chelmsford, MA (US); John Caleb Franklin, Londonderry, NH (US)

Correspondence Address: WOLF GREENFIELD & SACKS, P.C., 600 ATLANTIC AVENUE, BOSTON, MA, 02210-2206, US

(73) Assignee: Luminus Devices, Inc., Woburn, MA (US)

(21) Appl. No.: 11/413,609

(22) Filed: Apr. 28, 2006

Related U.S. Application Data
(60) Provisional application No. 60/781,514, filed on Mar. 10, 2006.
(60) Provisional application No. 60/782,028, filed on Mar. 13, 2006.

(51) Int. Cl. G02F 1/13; G09G 3/18

(52) U.S. Cl. 349/1; 345/50

(57) ABSTRACT

Thermal management of optical systems including illumination systems is provided. The optical systems may utilize LEDs as a light source. The LEDs may be supported on a heat pipe. The heat pipe facilitates conduction and dissipation of heat generated by the LEDs which may otherwise damage components of the optical system.

### RELATED APPLICATIONS

This application claims priority under 35 U.S.C. § 119(e) to U.S. Provisional Application Ser. No. 60/781,514, filed on Mar. 10, 2006, and U.S. Provisional Application Ser. No. 60/782,028, filed on Mar. 13, 2006, which are herein incorporated by reference in their entirety.

### FIELD

The present embodiments are drawn generally towards optical systems, and more specifically to illumination systems and/or display systems, such as liquid crystal display systems (LCDs). Specifically, the methods and systems of at least some of the embodiments include those that manage thermal effects in optical systems, and more specifically display systems, which include light-emitting diodes (LEDs) as light sources.

### BACKGROUND

Liquid Crystal Display (LCD) systems have increased in popularity and availability during recent years due to their light weight, high brightness and size. Likewise, as LCD technology has developed so has enabling technology such that LCD systems are now commonly backlit by an array or multiple arrays of LEDs. However, because of the low brightness output of certain conventional LEDs, a large number of LEDs are used to illuminate the LCD. The larger number of LEDs results in complex LED arrangement requiring significant assembly. Therefore, a method and system that can reduce the number of LEDs, and the integration complexity of such LEDs, in LCD systems is desirable.

### SUMMARY

Thermal management systems for optical systems, such as display systems and/or illumination systems, are described.

In one aspect, an LCD display system is provided comprising a thermal management system, at least one LED, and an illumination panel. The at least one LED is supported by the thermal management system, and the illumination panel is associated with the LED such that light emitted from the LED enters the illumination panel through an edge of the illumination panel. The LCD display system further comprises a LCD layer disposed over the illumination panel.

In another aspect, a method of forming an LCD display system is provided. The method comprises associating an illumination panel having an edge with an LED and a thermal management system such that light emitted from the LED enters the illumination panel through the edge of the illumination panel.

In another aspect, a display system is provided that comprises a heat pipe, at least one LED, and an illumination panel. The at least one LED is supported by the heat pipe, and the illumination panel is associated with the LED such that light emitted from the LED enters the illumination panel.

In another aspect, a method of forming a display system is provided. The method comprises supporting an LED on a heat pipe, and associating an illumination panel with the LED and the heat pipe such that light emitted from the LED enters the illumination panel.

In another aspect, a LCD display system is provided comprising a thermal management system, at least one LED, an illumination panel, and a LCD layer. The at least one LED is supported by the thermal management system and arranged so that the LED emits light in a direction parallel to the thermal management system. The illumination panel is associated with the LED such that light emitted from the LED enters the illumination panel, wherein the illumination panel is substantially parallel with the thermal management system. The LCD layer is disposed over the illumination panel.

In another aspect, a method of forming a LCD display system is provided. The method comprises supporting an LED on a thermal management system such that the LED emits light in a direction parallel to the heat pipe.

In another aspect, an optical system is provided comprising a thermal management system, at least one LED, wherein the at least one LED is supported by the thermal management system, and an optical component associated with the LED such that light emitted from the LED enters the optical component.

In another aspect, an optical system is provided comprising a thermal management system, at least one LED, wherein the at least one LED is supported by the thermal management system, and an optical component associated with the LED such that light emitted from the LED enters the optical component through an edge of the optical component.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF DRAWINGS

FIG. 1 shows an optical system including an LED supported by a thermal management system and optically coupled to an optical component, according to an embodiment;

FIG. 2 shows an LED die, according to an embodiment;

FIG. 3 illustrates a representative LED surface having a dielectric function that varies spatially, according to an embodiment;

FIGS. 4A-4C illustrate various optical components which may be part of an optical system, according to an embodiment;

FIGS. 5A-5D illustrate a thermal management system comprising a heat pipe, which may be part of an optical system, according to an embodiment;

FIGS. 6A-6C show thermal management systems including heat pipes in thermal contact with at least one protrusion, according to an embodiment;

FIGS. 7A-7F illustrate thermal management systems including heat pipes in thermal contact with a plurality of protrusions, according to an embodiment;

FIGS. 8A-8C show views of an assembly that includes LED(s) supported by a heat pipe, according to an embodiment;

FIGS. 9A-9B illustrate assemblies that can include a plurality of LEDs supported by a heat pipe, according to an embodiment;

FIG. 10 illustrates an LCD system which includes an assembly of one or more LEDs and a heat pipe, according to an embodiment;

FIG. 11A shows an edge-lit LCD system including LEDs and a heat pipe assembly, according to an embodiment;

FIG. 11B shows an edge-lit LCD system including LEDs and a plurality of heat pipe assemblies, according to an embodiment;

FIG. 11C shows an edge-lit LCD system including a plurality of modular panel members, according to an embodiment; and

FIG. 12A-12E illustrate display systems including LEDs, according to various embodiment.

### DETAILED DESCRIPTION

One or more embodiments presented herein include thermal management systems that may be incorporated in optical systems, such as display systems and/or illumination systems. As described further below, examples of display systems include LCD systems, and examples of illumination systems include illumination panels, cylinders, and other suitable shapes. It has been appreciated by the inventors that LEDs used as the light source of an optical system, such as LCD systems, may be supported on a thermal management system, such as one or more heat pipes. As described further below, the thermal management system can facilitate conduction and dissipation of heat generated by LEDs, and/or other components, which may otherwise degrade components of the optical system. Such a thermal management system may be particularly desirable when used in conjunction with high brightness LEDs which may generate a significant amount of heat within an optical system. High brightness LEDs may be particularly desirable since their use can reduce the number of LEDs that are incorporated into optical systems, such as LCD systems, and therefore effective thermal management of such high brightness LEDs is of particular interest.

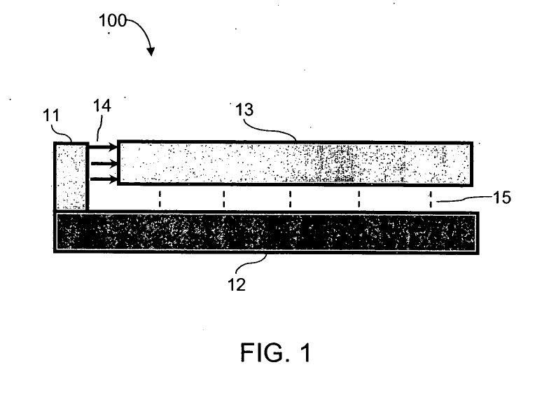

FIG. 1 shows an optical system 100 that includes an LED 11 supported by a thermal management system 12, where the LED 11 is optically coupled to an optical component 13. In some embodiments, optical system 100 may be a display system, such as an LCD system. In other embodiments, optical system 100 may be an illumination system, such as an illumination panel.

LED 11 may be an LED die, a partially packaged LED die, or a fully packaged LED. Furthermore, LED 1 may include a plurality of LED dies, for example a red-light emitting LED, a green-light emitting LED, and/or a blue-light emitting LED.

As used herein, an LED may be an LED die, a partially packaged LED die, or a fully packaged LED die. It should be understood that an LED may include two or more LED dies associated with one another, for example a red-light emitting LED die, a green-light emitting LED die, a blue-light emitting LED die, a cyan-light emitting LED die, or a yellow-light emitting LED die. For example, the two or more associated LED dies may be mounted on a common substrate (e.g., a common package). The two or more LED dies may be associated such that their respective light emissions may be combined to produce a desired spectral emission. The two or more LED dies may also be electrically associated with one another (e.g., connected to a common ground).

In some embodiments, thermal management system 12 supports the LED 11, and can facilitate the conduction and dissipation of heat generated by the LED 11. Thermal management system 12 may include passive and/or an active heat exchanging mechanisms. In some embodiments, the thermal management system 12 can include one or more heat pipes, a heat sink, a thermal electric cooler, a fan, and/or a circulation pump. In some embodiments, thermal management system 12 may also facilitate the conduction and dissipation of heat generated within the optical component 13, as depicted schematically by dashed lines 15. Such cooling may be accomplished via thermal communication (e.g., thermal contact) between the optical component 13 and the thermal management system.

Optical component 13 may include one or more components composed of material(s) that can transmit, diffuse, homogenize, and/or emit some or all of the light transmitted therein. Optical component 13 may be arranged so that at least some light 14 emitted from the LED enters the optical component 13. In some embodiments, optical component 13 may include scattering centers that can diffuse, scatter, homogenize, and/or emit some or all of the light transmitted therein so that light may exit along some or all of the length of the optical component 13. As discussed further below, the optical component may be an LCD panel.

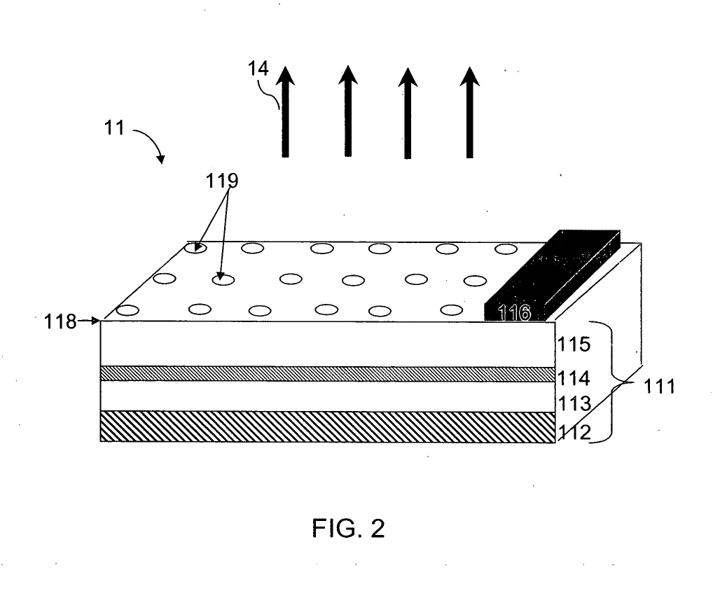

FIG. 2 shows an LED die that may be the light-generating component of a packaged LED. It should also be understood that various embodiments presented herein can also be applied to other light-emitting devices, such as laser diodes. The LED 11 shown in FIG. 2 comprises a multi-layer stack 111 that may be disposed on a sub-mount (not shown). The multi-layer stack 111 can include an active region 114 which is formed between n-doped layer(s) 115 and p-doped layer(s) 113. The stack can also include an electrically conductive layer 112 which may serve as a p-side contact, which can also serve as an optically reflective layer. An n-side contact pad 116 is disposed on layer 115. It should be appreciated that the LED is not limited to the configuration shown in FIG. 2, for example, the n-doped and p-doped sides may be interchanged so as to form a LED having a p-doped region in contact with the contact pad 116 and an n-doped region in contact with layer 112. As described further below, electrical potential may be applied to the contact pads which can result in light generation within active region 114 and emission of at least some of the light generated through an emission surface 118. As described further below, openings 119 may be defined in an interface of the LED through which light may be transmitted (e.g., emission surface 118) to form a pattern that can influence light emission characteristics, such as light extraction and/or light collimation. It should be understood that other modifications can be made to the representative LED structure presented, and that embodiments are not limited in this respect.

The active region of an LED can include one or more quantum wells surrounded by barrier layers. The quantum well structure may be defined by a semiconductor material layer (e.g., in a single quantum well), or more than one semiconductor material layers (e.g., in multiple quantum wells), with a smaller band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as well as combinations and alloys thereof), and/or other semiconductors.

The n-doped layer(s) 115 can include a silicon-doped GaN layer (e.g., having a thickness of about 300 nm thick) and/or the p-doped layer(s) 113 include a magnesium-doped GaN layer (e.g., having a thickness of about 40 nm thick). The electrically conductive layer 112 may be a silver layer (e.g., having a thickness of about 100 nm), which may also serve as a reflective layer (e.g., that reflects upwards any downward propagating light generated by the active region 114). Furthermore, although not shown, other layers may also be included in the LED; for example, an AlGaN layer may be disposed between the active region 114 and the p-doped layer(s) 113. It should be understood that compositions other than those described herein may also be suitable for the layers of the LED.

As a result of openings 119, the LED can have a dielectric function that varies spatially according to a pattern which can influence the extraction efficiency and collimation of light emitted by the LED. In the illustrative LED 11, the pattern is formed of openings, but it should be appreciated that the variation of the dielectric function at an interface need not necessarily result from openings. Any suitable way of producing a variation in dielectric function according to a pattern may be used. For example, the pattern may be formed by varying the composition of layer 115 and/or emission surface 118. The pattern may be periodic (e.g., having a simple repeat cell, or having a complex repeat super-cell), periodic with de-tuning, or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimidean patterns. In some embodiments, a complex periodic pattern can have certain openings with one diameter and other openings with a smaller diameter. As referred to herein, a non-periodic pattern is a pattern that has no translational symmetry over a unit cell that has a length that is at least 50 times the peak wavelength of light generated by active region 114. Examples of non-periodic patterns include aperiodic patterns, quasi-crystalline patterns, Robinson patterns, and Amman patterns.

In certain embodiments, an interface of a light-emitting device is patterned with openings which can form a photonic lattice. Suitable LEDs having a dielectric function that varies spatially (e.g., a photonic lattice) have been described in, for example, U.S. Pat. No. 6,831,302 B2, entitled “Light Emitting Devices with Improved Extraction Efficiency,” filed on Nov. 26, 2003, which is herein incorporated by reference in its entirety. A high extraction efficiency for an LED implies a high power of the emitted light and hence high brightness which may be desirable in various optical systems.

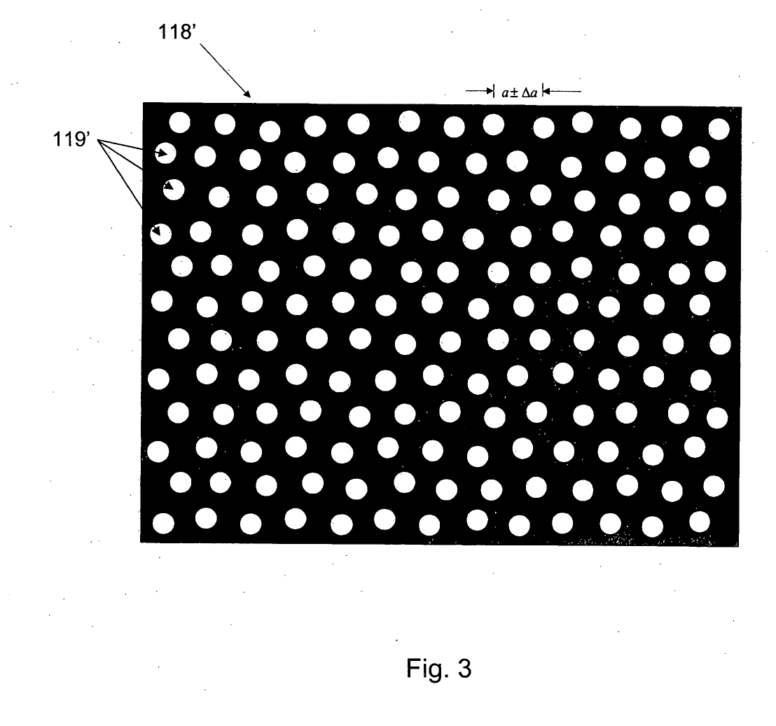

FIG. 3 illustrates a representative LED emitting surface 118′ having a dielectric function that varies spatially. In this example, the spatial variation of the dielectric function is a result of openings in the emitting surface 118′ of the LED. The emitting surface 118′ is not flat, but rather consists of a modified triangular pattern of openings 119′. In general, various values can be selected for the depth of openings 119′, the diameter of openings 119′ and/or the spacing between nearest neighbors in openings 119′. The triangular pattern of openings may be detuned so that the nearest neighbors in the pattern have a center-to-center distance with a value between (a−Δa) and (a+Δa), where “a” is the lattice constant for an ideal triangular pattern and “Δa” is a detuning parameter with dimensions of length and where the detuning can occur in random directions. In some embodiments, to enhance light extraction from the LED, a detuning parameter, Δa, is generally at least about one percent (e.g., at least about two percent, at least about three percent, at least about four percent, at least about five percent) of ideal lattice constant, a, and/or at most about 25% (e.g., at most about 20%, at most about 15%, at most about 10%) of ideal lattice constant, a. In some embodiments, the nearest neighbor spacings vary substantially randomly between (a−Δa) and (a+Δa), such that pattern of openings is substantially randomly detuned. For the modified triangular pattern of openings 119′, a non-zero detuning parameter enhances the extraction efficiency of the LED. It should be appreciated that numerous other modifications are possible to the interfaces (e.g., emitting surface) of an LED while still achieving a dielectric function that varies spatially.

It should also be understood that other patterns are also possible, including a pattern that conforms to a transformation of a precursor pattern according to a mathematical function, including, but not limited to an angular displacement transformation. The pattern may also include a portion of a transformed pattern, including, but not limited to, a pattern that conforms to an angular displacement transformation. The pattern can also include regions having patterns that are related to each other by a rotation. A variety of such patterns are described in U.S. patent application Ser. No. 11/370,220, entitled “Patterned Devices and Related Methods,” filed on Mar. 7, 2006, which is herein incorporated by reference in its entirety.

Light may be generated by LED 11 in FIG. 2 as follows. The p-side contact layer 112 can be held at a positive potential relative to the n-side contact pad 116, which causes electrical current to be injected into the LED. As the electrical current passes through the active region, electrons from n-doped layer(s) 115 can combine in the active region with holes from p-doped layer(s) 113, which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED (shown by arrows 14) may be influenced by any patterned interface (e.g., the emission surface 118) through which light passes, whereby the pattern can be arranged so as to influence light extraction and collimation.

In other embodiments, the active region can generate light having a peak wavelength corresponding to ultraviolet light (e.g., having a peak wavelength of about 370-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm).

In certain embodiments, the LED may emit light having a high power. As previously described, the high power of emitted light may be a result of a pattern that influences the light extraction efficiency of the LED. For example, the light emitted by the LED may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from an LED can be measured by using an integrating sphere equipped with spectrometer, for example a SLM12 from Sphere Optics Lab Systems. The desired power depends, in part, on the optical system that the LED is being utilized within. For example, a display system (e.g., a LCD system) may benefit from the incorporation of high brightness LEDs which can reduce the total number of LEDs that are used to illuminate the display system.

The light generated by the LED may also have a high total power flux. As used herein, the term “total power flux” refers to the total power divided by the emission area. In some embodiments, the total power flux is greater than 0.03 Watts/mm², greater than 0.05 Watts/mm², greater than 0.1 Watts/mm², or greater than 0.2 Watts/mm². However, it should be understood that the LEDs used in systems and methods presented herein are not limited to the above-described power and power flux values.

In some embodiments, the LED may be associated with a wavelength-converting region (not shown). The wavelength-converting region may be, for example, a phosphor region. The wavelength-converting region can absorb light emitted by the light-generating region of the LED and emit light having a different wavelength than that absorbed. In this manner, LEDs can emit light of wavelength(s) (and, thus, color) that may not be readily obtainable from LEDs that do not include wavelength-converting regions.

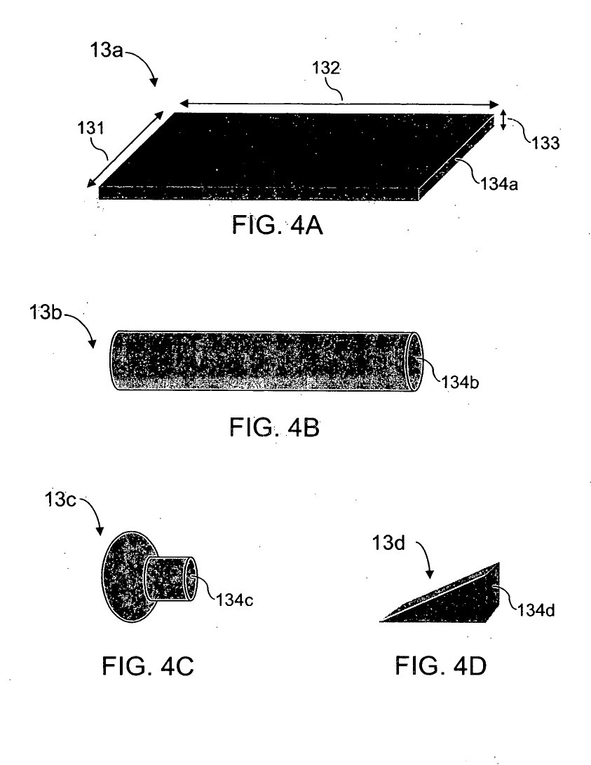

FIGS. 4A-4D illustrate embodiments of optical components which may be part of an optical system, such as the optical system illustrated in FIG. 1. One or more optical components may be included in the optical system. The optical component may have any desired shape, for example, the optical component may be a panel, a cylinder, or any other desired shape. FIG. 4A illustrates an optical component in the shape of a panel 13a, wherein the dimensions of the panel may be such that the length 132 and/or the width 132 are substantially larger than the thickness 133. In some embodiments, the thickness of the panel is less than 3 cm (e.g., less than 2 cm, less than 1 cm, less than 0.5 cm). In one embodiment, the length and/or width of the panel are less than 100 cm (e.g., less than 50 cm, less than 30 cm). In some embodiments, the length and/or width of the panel are at least 10 times greater (e.g., 20 times greater, 50 times greater, 100 times greater) than the thickness of the panel. FIG. 4B illustrates an optical component in the shape of a cylinder 13b. The cylinder may have any desired dimensions, for example, the dimensions may be similar to those of different types of fluorescent light fixtures or tubes. FIG. 4C illustrates an optical component in the shape of a bulb 13c. The bulb may have any desired dimensions, for example, the dimensions may be similar to those of different types of incandescent light bulbs. FIG. 4D illustrates an optical component in the shape of a wedge 13d (e.g., a wedge-optic). Some examples of optical components that may be part of optical systems, such as display systems, include wedge-optics, mixing regions, and illumination panels.

The optical component may be formed of one or more materials including materials that are translucent and/or semi-translucent. Examples of materials that may be used to form the optical components include polycarbonate and PMMA (polymethylmethacrylate). In some embodiments, the optical component may be formed of material(s) that can transmit, diffuse, scatter, homogenize, and/or emit some or all of the light transmitted therein. The optical component may be arranged in an optical system so that light emitted from at least one LED enters the optical component. For example, in some arrangements, light from at least one LED may enter the optical component through an edge. In other embodiments, a plurality of LEDs may be arranged to emit light into the optical component. Furthermore, LEDs may be arranged to emit light into different edges and/or corners of the optical component. In the panel embodiment shown in FIG. 4A, light from an LED may enter via edge 134a of the panel and/or via any one of the corners of the panel. In the cylindrical embodiment shown in FIG. 4B, light from an LED may enter via edge 134b of the cylinder. In the bulb embodiment shown in FIG. 4C, light from an LED may enter via edge 134c of the bulb. In the wedge embodiment shown in FIG. 4D, light from an LED may enter via edge 134d of the wedge, and/or any other suitable edge. Although the edges in the illustrative embodiments of FIG. 4A-4D are flat surfaces, it should be appreciated that an edge need not necessarily have a flat surface. For instance, an edge may have any suitable shape, including a rounded surface, a concave surface, and/or a convex surface.

In some embodiments, an optical component may include one or more cavities and/or recesses that may be capable of receiving one or more LEDs. The cavity and/or recess may be formed on the surface of an optical component and can be used to facilitate the assembly of an optical system that can include the optical component and one or more LEDs that emit light into the optical component. In other embodiments, one or more LEDs may be embedded in the optical component. For example, one or more LEDs may be embedded into the optical component during the formation of optical component. When the optical component is formed with a molded material (e.g., using a mold injection process), one or more LEDs may be embedded into the optical component during the molding process. When the optical component is formed by joining multiple parts, one or more LEDs may be embedded in between the multiple parts. It should be appreciated that these are just some examples of methods by which one or more LEDs may be coupled to and/or embedded into an optical component and various modifications are possible.

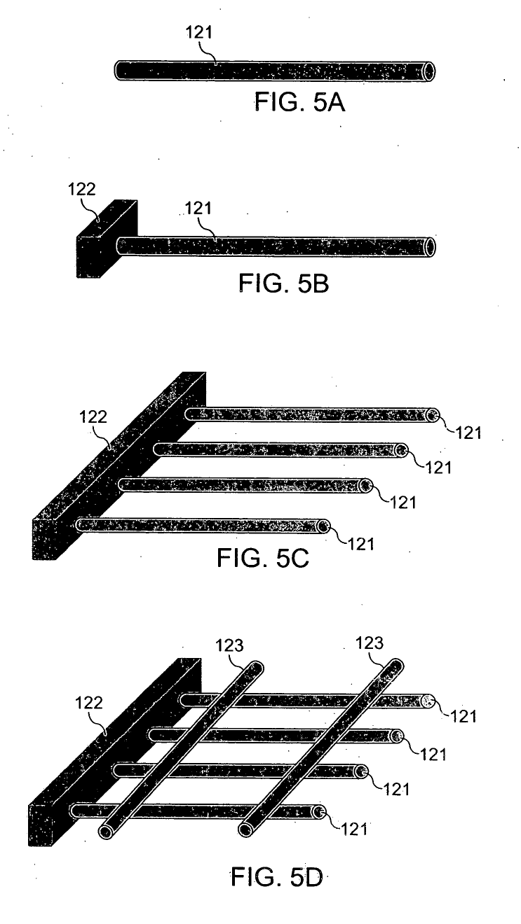

FIGS. 5A-5D illustrate embodiments of thermal management systems including one or more heat pipes. Generally, a thermal management system may include a suitable system that can conduct and dissipate heat which may be generated within devices and components of the optical system. Devices that generate heat may include LEDs, especially high brightness LEDs, and components of an optical system, as described previously. In one embodiment of a display system, an optical component which may generate and/or transmit heat is an illumination panel which may be disposed underneath display layers, such as a liquid crystal optical film (not shown). In some embodiments, a thermal management system may be characterized by, or may include one or more components that are characterized by, a thermal conductivity greater than 5,000 W/mK, greater than 10,000 W/mK, and/or greater than 20,000 W/mK. In some embodiments, the thermal conductivity lies in a range between 10,000 W/mK and 50,000 W/mK (e.g., between 10,000 W/mK and 20,000 W/mK, between 20,000 W/mK and 30,000 W/mK, between 30,000 W/mK and 40,000 W/mK, between 40,000 W/mK and 50,000 W/mK).

In some embodiments, a thermal management system can include passive and/or active heat exchanging mechanisms. Passive thermal management systems can include structures formed of one or more materials that rapidly conduct heat as a result of temperature differences in the structure. Thermal management systems may also include one or more protrusions which can increase the surface contact area with the surrounding ambient and therefore facilitate heat exchange with the ambient. In some embodiments, a protrusion may include a fin structure that may have a large surface area.

In a further embodiment, a thermal management system can include channels in which fluid (e.g., liquid and/or gas) may flow so as to aid in heat extraction and transmission. For example, the thermal management system may comprise a heat pipe to facilitate heat removal. Various heat pipes are well known to those in the art, and it should be understood that the embodiments presented herein are not limited to merely such examples of heat pipes. Heat pipes can be designed to have any suitable shape, and are not necessarily limited to only cylindrical shapes. Other heat pipe shapes may include rectangular shapes which may have any desired dimensions.

In some embodiments, one or more heat pipes may be arranged such that a first end of the heat pipes is located in regions of the optical system that are exposed to high temperatures, such as in proximity to one or more LEDs in the optical system. A second end of the heat pipes (i.e., a cooling end) may be exposed to the ambient. The heat pipes may be in thermal contact with protrusions to aid in heat exchange with the ambient by providing increased surface area. Since heat pipes may have a thermal conductivity that is many times greater (e.g., 5 times greater, 10 times greater) than the thermal conductivity of many metals (e.g., copper), the conduction of heat may be improved via the incorporation of the heat pipes into optical systems, such as display and illumination systems.

Active thermal management systems may include one or more suitable means that can further aid in the extraction and transmission of heat. Such active thermal management systems can include mechanical, electrical, chemical and/or any other suitable means to facilitate the exchange of heat. In one embodiment, an active thermal management system may include a fan used to circulate air and therefore provide cooling. In another embodiment, a pump may be used to circulate a fluid (e.g., liquid, gas) within channels in the thermal management system. In further embodiments, the thermal management system may include a thermal electric cooler that may further facilitate heat extraction.

FIG. 5A illustrates a thermal management system including a heat pipe 121 which may be part of an optical system, such as a display or illumination system. The heat pipe may be in thermal contact with one or more LEDs, so that heat generated within the LED may be readily transmitted along the heat pipe. Heat transmitted along the heat pipe may be transferred to the surrounding ambient and/or transferred to surrounding heat exchanging components. Examples of heat exchanging elements can include protrusions which may have increased surface area and therefore may aid in the transfer of heat to the surrounding ambient, as described further below. Heat pipe 121 may also be electrically conductive and one or more LEDs supported by the heat pipe may be electrically connected to the heat pipe. LED dies, such as those illustrated in FIG. 2, may be mounted on the heat pipe 121 so that the LED conductive layer 112 is electrically connected to heat pipe 121 through an electrically conductive attachment material. In some embodiments, one or more LEDs are mounted on a heat pipe with a thermally conductive attachment material, such as a thermally conductive epoxy.

FIG. 5B illustrates another thermal management system that includes a heat pipe 121 in thermal contact with an interposer component 122. The interposer component 122 may be formed of a material that possesses a high thermal conductivity, such as copper. In some embodiments, the interposer component may support one or more LEDs, as discussed further below. Interposer component 122 may also be electrically conductive and one or more of the LEDs may be electrically connected to the interposer component 122. LED dies, such as those illustrated in FIG. 2, may be mounted on the interposer component so that the LED conductive layer 112 is electrically connected to the interposer component 122. In some embodiments, one or more LEDs are mounted on the interposer component with a thermally conductive attachment material, such as a thermally conductive epoxy.

In further embodiments, a plurality of interposer components, each associated with one or more respective heat pipes supporting one or more LEDs, may be thermally coupled with a common heat pipe that is in thermal contact with each of the interposer components. To facilitate assembly, each interposer component may possess a hole (e.g., though its center) so that the common heat pipe that thermally connects all the interposer components may be inserted through the hole of each interposer component, thereby forming an array of interposer components.

FIG. 5C illustrates another thermal management system that includes a plurality of heat pipes. In some embodiments, at least some of the heat pipes can have differing thermal conductances. Differing thermal conductances may be achieved by varying the size of heat pipe and/or internal composition. In the illustration of FIG. 5C, the heat pipes 121 are arranged to form an array, which may be such that the heat pipes are substantially parallel. It should be understood that in other arrays, the heat pipes may have any relative orientation, and are not necessarily parallel. In some embodiments, a plurality of heat pipes may be arranged to be parallel to an optical component of an optical system. In some embodiments, where the optical component comprises an illumination component, such as an illumination panel of a display system or an illumination system, the plurality of heat pipes may be arranged to be disposed underneath a portion or substantially all of the illumination panel. For example, the array of heat pipes may be disposed beneath at least 50% (e.g., at least 75%, at least 90%) of the area of the illumination panel. Such an arrangement may be desirable in display systems having thermal management systems that can extract and dissipate heat generated by LEDs and/or other components that form the display system. In some embodiments, as illustrated in FIG. 5C, an interposer component 122 may be in thermal contact with a plurality of heat pipes. Furthermore, LEDs may be supported by the interposer component 122, as described in relation to FIG. 5B.

FIG. 5D illustrates another thermal management system that includes an array of heat pipes further arranged so that two or more of the heat pipes partially overlie each other. As in the embodiment illustrated in FIG. 5C, a plurality of heat pipes 121 may be arranged in a desired configuration, for example a substantially parallel configuration. Furthermore, one or more heat pipes 123 may be arranged to at least partially overlie some or all of the heat pipes 121. The heat pipes that overlie each other may be arranged to have any desired angle of intersection, for example, the heat pipes that overlie each other may be substantially perpendicular, parallel, or form any other angle. Heat pipes 123 and 124 may be in thermal contact with some or all of the heat pipes 121. Thermal contact may be achieved via an attachment material between the heat pipes that overlie each other. The attachment material may be a suitably thermally conductive attachment material, such as a solder. Such an arrangement may be desirable when an optical component disposed over the thermal management system possesses regions that may have a higher operating temperature than other regions. For example, a mixing region within an illumination panel component or optically coupled to an illumination panel (in a display system or illumination system) may be at a higher operating temperature than other regions of the illumination panel. As such heat pipes (such as heat pipes 123 and/or 124) may be arranged be lie substantially underneath the mixing regions of the illumination panel and therefore may facilitate the extraction of heat from those higher temperature regions of the illumination panel.

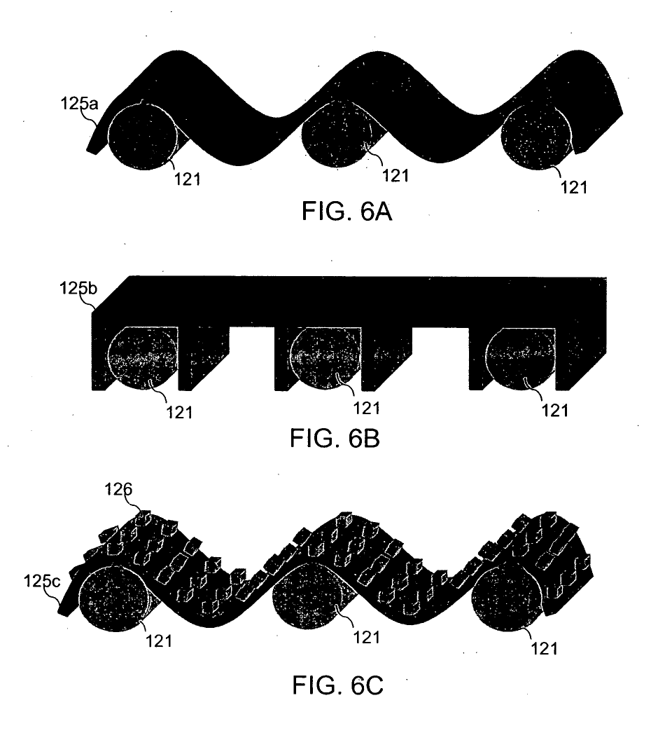

FIGS. 6A-6C illustrate embodiments of thermal management systems including heat pipes in thermal contact with at least one protrusion. In some embodiments, the heat pipes can be in direct or thermal communication with at least one protrusion. One or more heat pipes can be in direct thermal communication with a plurality of protrusions which can form a heat sink. Protrusions can have any desired shape and can include suitable structures that have increased surface contact area with the surrounding ambient, as compared to heat pipes by themselves. As a result of the increased surface area, the protrusions may therefore facilitate heat exchange with the ambient. In some embodiments, a protrusion may include a fin structure that may have a large surface area. The fin structure may be formed of a thermally conductive material having a suitably high thermal conductivity, such as copper and/or aluminum. FIG. 6A illustrates an embodiment of a thermal management system wherein a plurality of heat pipes 121 are in thermal contact with a fin 125a. In this illustrative embodiment, the fin 125a has a wave-like shape and can readily accommodate heat pipes having a variety of different cross-section sizes (e.g., different diameters).

One or more heat pipes may be fixed to one or more protrusions (e.g., fins) with a suitable attachment material, including solder (e.g., an alloy between two or more metals such as gold, germanium, tin, indium, lead, silver, molybdenum, palladium, antimony, zinc, etc.), metal-filled epoxy, thermally conductive adhesives (such as those offered by Diemat, Inc. of Byfield, Mass.), metallic tape, thermal grease, and/or carbon nanotube-based foams or thin films. Thermally conductive attachment materials typically have a suitably high thermal conductivity and therefore a low thermal resistance per unit contact area.

It should be appreciated that a variety of fin structures are possible which may have increased surface area, and embodiments are not limited to the wave-like fin structure illustrated in FIG. 6A. FIG. 6B illustrates a fin structure 125b having rectangular-shaped compartments within which heat pipes 121 may be disposed. The heat pipes may be in thermal contact with one or more sides of the rectangular compartments. In the illustrated embodiment, the heat pipes are in contact with all the sides of the rectangular compartments, although other embodiments are not necessarily limited in this respect.

In some embodiments, a protrusion, for example a fin, may have a portion or all of its surface textured. The surface texture may comprise dimples, grooves, corrugated patterns, and/or pin-like extensions. Textured surfaces may improve heat transfer to the surrounding ambient by increasing contact area with the ambient. Also, some textured surfaces, such as a dimpled surface, may reduce the air resistance of the surface by creating small air pockets during air flow across the surface. Additionally, or alternatively, protrusions (e.g., a fin), may include surface coatings that can reduce the air resistance of the surface and thereby allow air to freely flow across the surface and remove heat therefrom via convection. FIG. 6C illustrates an embodiment of a fin 125c having a textured surface comprising a corrugated pattern 126.

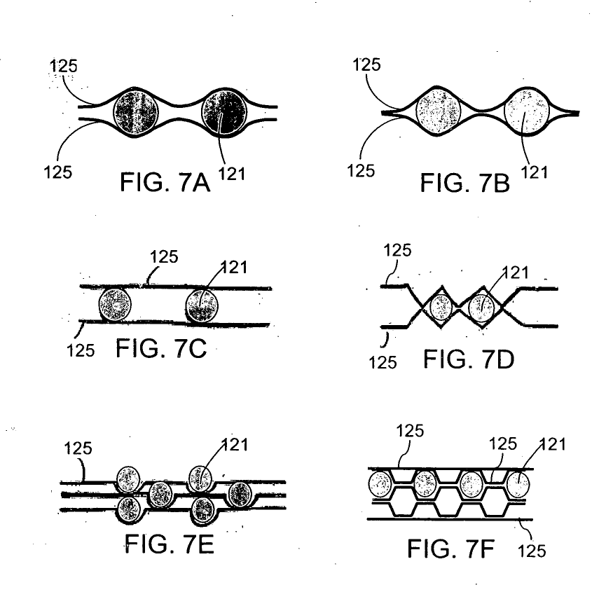

FIGS. 7A-7F illustrate embodiments of thermal management systems including heat pipes in thermal contact with a plurality of protrusions. Protrusions, such as fins, may be stacked so as to form multiple layers. In some embodiments, fins can also be bent or shaped into any desired configuration. Multiple heat pipes can be placed between two or more fin layers to increase the removal of heat from the optical system (e.g., as shown in FIGS. 7A, 7B and 7C). Fins may be formed of materials that can be readily shaped to the contours of the heat pipes. As illustrated in FIG. 7A, two fins 125 may be partially shaped around heat pipes 121 but the fins need not necessarily be in contact with each other. Also, as shown in the illustration of FIG. 7B, two fins may be contacted in some regions and/or not contacted in other regions. Furthermore, as shown in FIG. 7C, the fins may be substantially straight and need not necessarily be shaped to the contours of the heat pipes. Also, as shown in FIG. 7D, the fins may be shaped to have cornered edges so that heat pipes may readily be placed within the cornered portions of the fins.

In some embodiments, as shown in FIGS. 7E and 7F, multiple layers of fins may be arranged to accommodate multiple heat pipes. FIG. 7E illustrates an embodiment where multiple layers of fins house heat pipes on each layer. In some embodiments, multiple layers of fins may be shaped into a honeycomb geometric configuration, as illustrated in FIG. 7F. Such a configuration can increase the surface area of the fins, thereby increasing the effectiveness of transferring to the surrounding ambient. In some embodiments, strategically placing heat pipes across the back of an illumination panel of a display system can provide a uniform distribution of heat and can improve the operation of the display system. The heat pipes and/or protrusions may extend across and traverse one side of an optical component, such as a backside of an illumination panel (e.g., in a display system and/or an illumination system).

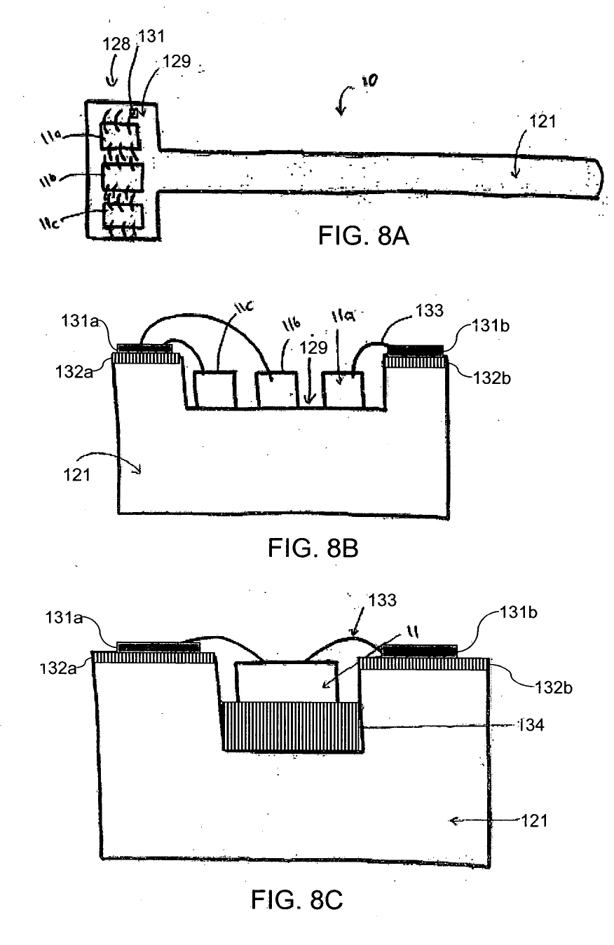

As previously described, an optical system may include an LED supported by a thermal management system, where the thermal management system may include a heat pipe. In other embodiments, a plurality of LEDs may be supported by a heat pipe. FIG. 8A illustrates a top-view of an assembly that includes a plurality of LEDs supported by a heat pipe. Assembly 10 includes LEDs 11a, 11b, 11c supported by a heat pipe 121 according to an embodiment. In some embodiments, the LEDs 11a, 11b, and 11c include a red-emitting LED, a green-emitting LED, and a blue-emitting LED. In the one embodiment, LED 11a is a red-emitting LED, LED 11b is a green-emitting LED, and LED 11c is a blue-emitting LED.

As shown, the LEDs are supported at a first end 128 of the heat pipe which includes a flattened region 129 which can facilitate mounting of the LEDs and/or can increase the surface area between the heat pipe and LEDs. However, it should be understood that the LEDs may be positioned at any location on the heat pipe including along its length. As shown in FIG. 8B, which is a side-view of an assembly that includes a plurality of LEDs supported by a heat pipe, a cavity may be formed at the first end 128 of the heat pipe, within which the LEDs may be embedded or housed. In such a configuration, the heat pipe can act as the submount for the LEDs. Electrical connections to the LEDs may be achieved via a variety of configurations. In some embodiments, as illustrated in FIGS. 8A and 8B, one or more electrical contacts 131a and 131b can be disposed adjacent the LEDs, while being supported by the heat pipe. An electrically insulating layer 132 may be disposed between the electrical contacts 131 and the heat pipe. The electrical contacts 131 may be connected to an external voltage source (not shown). In some embodiments, the electrical contacts 131a and 131b are connected to the same voltage source, whereas in other embodiments, the electrical contacts 131a and 131b are connected to different voltage sources, thereby enabling the control of electrical power that is supplied to individual LEDs. In such arrangements, one or more LEDs may be driven by different voltage sources, where the driving voltage may be based on a desired light output power for each LED in the assembly. A temperature sensor may be incorporated in the assembly to provide a measurement representative of the temperature of the assembly and/or of an optical component (e.g., an illumination panel) which is illuminated by the assembly. A control system (not shown) can receive an input signal representative of the temperature sensor measurement, and can output a signal that can control light emission from the LEDs, for example via the adjustment of the driving voltage supplied to each LED.

Wire connectors 133 may electrically connect the electrical contacts 131 to contact pads (not shown) on the LEDs so as to provide drive voltages to the LEDs. For example, when the LEDs are similar to the representative LED illustrated in FIG. 2, the wire connectors 133 may be connected to contact pad 116 (e.g., n-side contact pad). In such a configuration, the LED backside may be such that conductive layer 112 of the LED, as illustrated in FIG. 2, may be in electrical contact with the heat pipe. Since the heat pipe may be electrically conductive, the heat pipe itself can serve as an electrical contact to the LEDs having a polarity opposite to the electrical contacts 131. For example, the electrical contacts 131 may serve as n-side contacts and the heat pipe may serve as a p-side contact. Advantageously, this design may be such that the heat pipe, upon which one or more LEDs may be supported, provides both electrical connections to the LEDs as well as means for heat to be transferred away from the LEDs.

A suitable electrical connection between the backside of the LEDs and the heat pipe may be formed using an electrically conductive attachment material. Electrically conductive attachment materials can include solder. In some embodiments, the attachment material is thermally conductive and typically has a suitably high thermal conductivity.

FIG. 8C shows another embodiment in which an electrically insulating layer 134 is positioned between the heat pipe and an LED 11. In some embodiments, the electrically insulating layer 134 may be substantially thermally conductive. For example, the electrically insulating layer 134 may comprise aluminum nitride and/or a thermally conductive epoxy, though it should be understood that other electrically insulating materials may also be suitable. In the illustrative embodiment of FIG. 8C, electrical contact 131a may be electrically connected to an n-side contact pad of the LED and electrical contact 131b may be electrically connected to a p-side contact pad of the LED. In some embodiments, it may be desirable for the LED to have exposed n-side and p-side contact pads that may be readily electrically connected to via top-side wire bonds.

In general, heat pipe 121 may have any suitable configuration. For example, the heat pipe can include an outer wall (which may be tubular at least in some portions of the heat pipe) or housing that is configured to enclose a core, also known as a wick (not shown). The heat pipe can also house heat transfer fluid, such as water, that aids in the transfer of heat away from the LED. Heat pipes that incorporate fluid can be highly efficient heat exchangers due to the water undergoing a condensation and evaporation cycle, thereby rapidly transferring heat away from the LED.

In some embodiments, a heat pipe on which one or more LEDs are supported can include two sections. A first section may include the first end 128 on which the LEDs may be supported and a second section may include the tubular portion of the heat pipe. The first portion may be threadly coupled to the tubular portion of the heat pipe, although it should be appreciated that the first portion may be coupled to the tubular portion in any other suitable manner.

In another embodiment, an interposer component may be disposed between the LED and the heat pipe. The interposer component can allow for other heat pipes to connect thereto, as illustrated in FIGS. 5C-5D. Connecting multiple heat pipes together through an interposer component can create a heat pipe/heat exchanging network, whereby a uniform heat distribution network may be formed. Such a network can be advantageous were one LED is emitting more heat than the other LEDs at other locations on the network. The network can allow for the excess heat to be distributed uniformly across the whole network. In such at network as previously described the heat pipes can be interconnected with interposer components located near the LEDs or at the opposite end of the heat pipe.

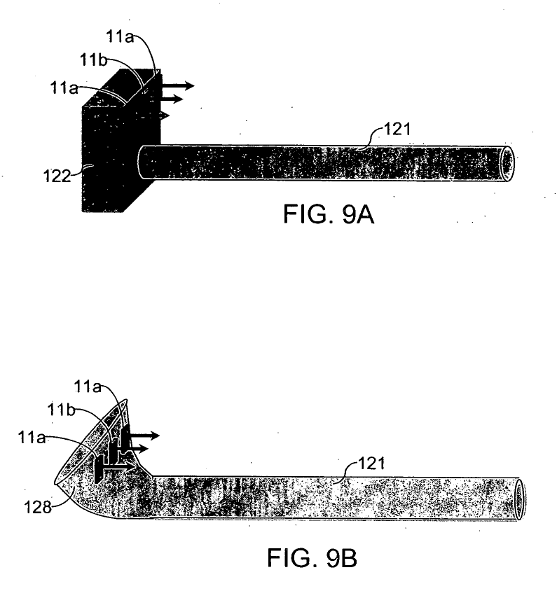

FIGS. 9A and 9B illustrate other assemblies that can include a plurality of LEDs supported by a heat pipe, wherein light emission from the LEDs is substantially parallel to the heat pipe length. In such configurations, LEDs (e.g., 11a, 11b, 11c) are supported by at least one heat pipe 121 so that light emission from the LEDs is substantially parallel to the length of the heat pipe. Such a configuration may be desirable when incorporating LEDs with a thermal management system, including at least one heat pipe, in an optical system such as a display system or illumination panel. FIG. 9A shows LEDs mounted on an interposer component 122 connected to a heat pipe 121. FIG. 9B shows LEDs mounted on a heat pipe 121 having a substantially flattened end 128. The flattened end 128 of the heat pipe may be such that the surface normal of the flattened end may be substantially parallel to the length of the tubular portion of the heat pipe.

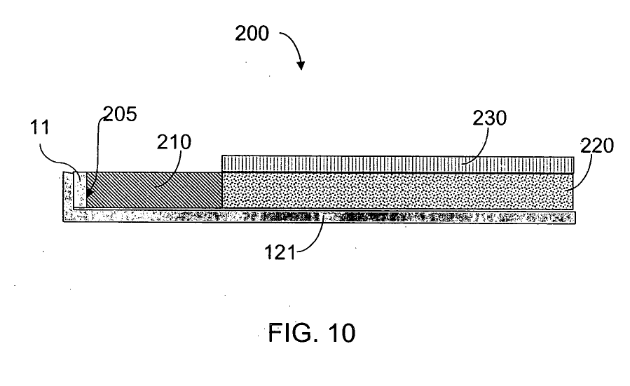

FIG. 10 illustrates a side-view of an LCD system which includes an assembly of one or more LEDs and a thermal management system that can include a heat pipe. As described above, the LED(s) and heat pipe assembly may be incorporated into a display system, such as a LCD system. In these embodiments, one or more LEDs may be used as light sources for the LCD system. FIG. 10 shows a cross-section side-view of an LCD system 200 which includes assembly 10 of LED 11 and heat pipe 121. In the illustrative embodiment, one or more LEDs are used for edge illumination of an illumination panel 220. A topside 205 of the LED(s) is oriented so that light is emitted into mixing region 210. In some cases, the light-emitting device may be directly attached to the mixing via continuous encapsulation. The mixing region can mix or homogenize incoming light emitted from the LEDs and emit a substantially uniform light output which may be directed into illumination panel 220. Illumination panel 220 may include scattering centers that can output light substantially evenly along its length and into LCD layers 230. LCD layers 230 can pixilate and separate light into colors so as to create images which may be viewed by a user. In other embodiments, LCD layers 230 may be absent and the light-emitting panel assembly may be used as an illumination system for general illumination or any other suitable purpose.

In the illustrative embodiment, heat pipe 121 extends across a back surface of the LCD system. In some embodiments, a support structure (not shown) may be positioned between the heat pipe and the illumination panel and/or mixing region, though it should be understood that in other embodiments a separate support structure may not necessarily be present. The heat pipe can be attached to the illumination panel or support (when present) or it can be spaced away from the illumination panel or support in order to facilitate heat removal with the ambient. The embodiments are not limited to configurations wherein the heat pipe wraps around the backside of the light panel. In one embodiment, the heat pipe could be incorporated around the edges of the panel and/or integrated with a frame encasing the edges of the panel. The heat pipe may be in thermal contact with protrusions to aid in heat exchange, as described above. It should be understood that one or more heat pipes may be used per light-emitting device.

The support (e.g., a back-plate), when present, may be in thermal contact with the heat pipe and can additionally act as a heat sink for the LEDs. Thus, the support may further aid in the removal of heat from within the display. The support may also include a reflective layer to help guide light propagating in panel 220 towards the emission surface (e.g., towards LCD layers 230). Typical materials that may form the support include aluminum, aluminum alloys, steel, or combinations thereof.

In some embodiments, the ability to remove heat from the LED can enable operation at high power levels (e.g., light-emitting devices having a total output power of greater than 0.5 Watts), as previously described. In some embodiments, the thermal management system can effectively dissipate at least 5 W, at least 10 W, at least 20 W. Due to potential for high output power light emission (i.e., high brightness) from the LEDs, the number of light-emitting devices that are used per unit length of the illumination panel may be reduced. In one embodiment, a high brightness light-emitting device can be used to edge illuminate an illumination panel length of about 2 inches or greater (e.g., greater than 4 inches, greater than 6 inches). In some such embodiments, the high brightness LED(s) has an emission power of greater than about 0.5 W and may include a plurality of LEDs that may have different color light emission, for example a red light-emitting die, a blue light emitting die, and a green light-emitting die.

Suitable LCD systems have been described in U.S. Patent Application Publication 2006/0043391, entitled “Light Emitting Devices for Liquid Crystal Displays,” filed Aug. 23, 2005, and U.S. patent application Ser. No. 11/323,176, filed Dec. 30, 2005, which are incorporated herein by reference. Other features presented herein can be to employ this thermal management system with an ultra-thin LCD system. LCD systems presented herein may typically have a thickness of less than 30 mm, less than 10 mm, less than 4 mm, less than 2 mm, or even less than 1 mm. It should be understood that the assemblies described herein can be used in a variety of optical systems other than display systems and illumination systems.

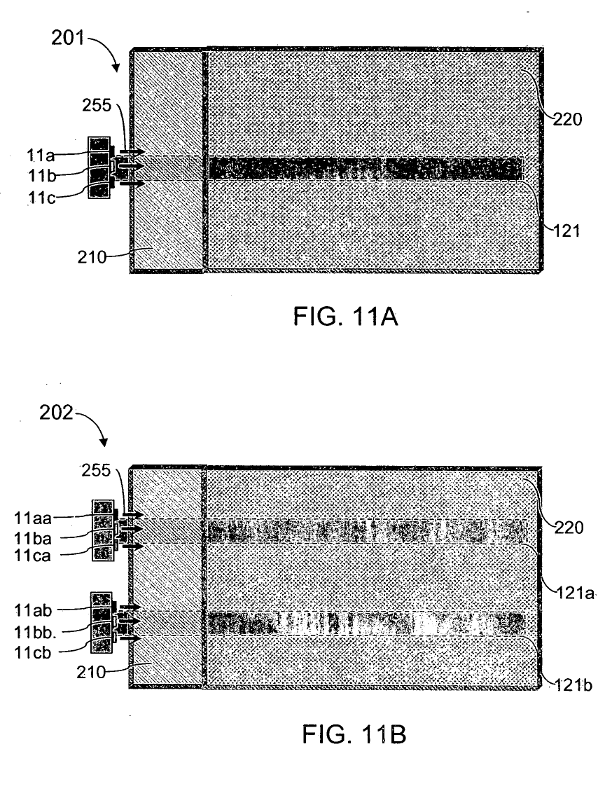

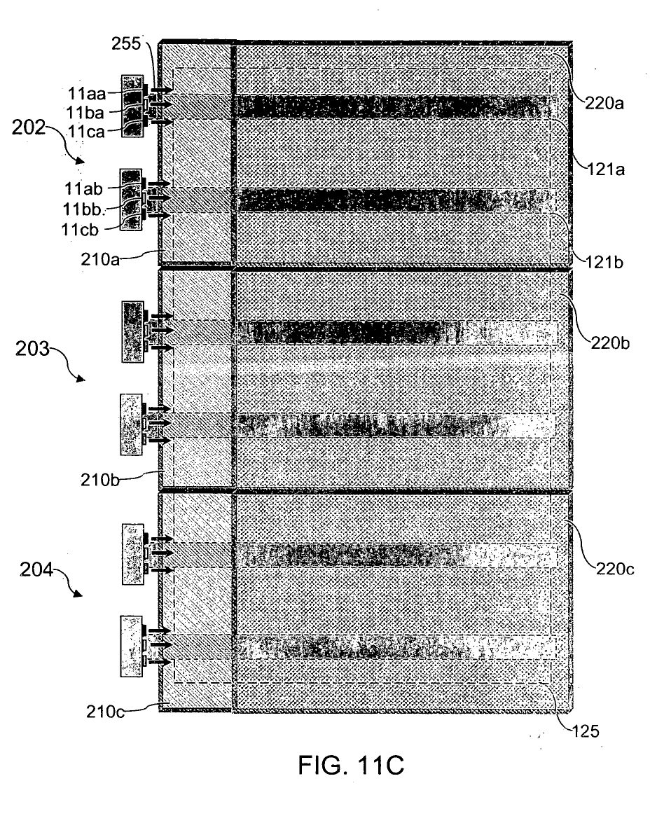

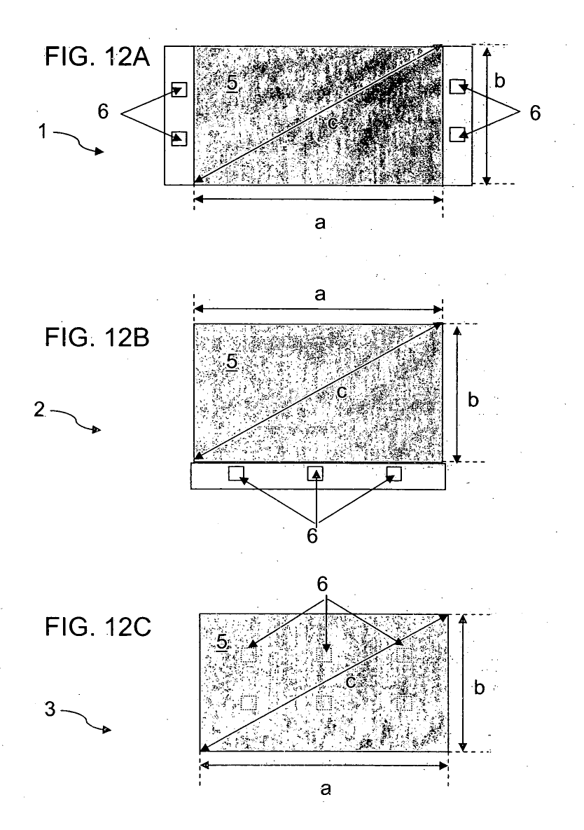

FIGS. 11A-11C illustrate top-views of edge-lit LCD systems including heat pipes, LEDs, and an edge-lit illumination panel. Such edge-lit LCD systems may be used, for example, as a backlight assembly for LCD televisions, but is should be appreciated that similar systems may also be used for general illumination, for example as illumination panels. In some embodiments, the thermal management system (e.g., including heat pipes) of the LCD may be substantially parallel to the illumination panel and/or may be disposed underneath the illumination panel, which may thereby facilitate the design of a compact LCD system.

FIG. 11A illustrates a top-view of an edge-lit LCD system 201 including LEDs supported by a heat pipe. In this illustrative embodiment, multiple LEDs 11a, 11b, and 11c may be supported by heat pipe 121, and arranged such that the direction of light emitted (represented by arrows 255) from the LEDs 11a, 11b, and 11c is substantially parallel to the heat pipe 121. In some embodiments, the assembly of the LEDs supported by the heat pipe may be an assembly similar to those previously described herein. The LEDs may be directly mounted on the heat pipe, on an interposer component as previously described, or on a package that is in turn directly mounted on the heat pipe or interposer component. As previously described, the heat pipes may be mounted with a suitable attachment material, which may be thermally conductive or insulating, and/or electrically conductive or insulating. In the illustrated embodiment, the heat pipes are disposed underneath an illumination panel 220 and a mixing region 210, as indicated by the dotted outline of the heat pipe 121 in FIGS. 11A-11C. Furthermore, the length of the heat pipes may be substantially parallel to the illumination panel.

It should be appreciated that although three LEDs are supported by the heat pipe in the illustrated embodiment, one or more LEDs may be supported. To allow for the generation of a desired color of light (e.g., white light) the plurality of LEDs 11a, 11b, 11c may be LEDs that generate different wavelengths of light. For example, a first LED can emit red light, a second LED can emit green light, and a third LED can emit blue light. In other embodiments, a first LED can emit red light, a second LED can emit green light, a third LED can emit blue light, and a fourth LED can emit cyan light. In other embodiments, a first LED can emit red light, a second LED can emit green light, a third LED can emit blue light, and a fourth LED can emit yellow light. In still other embodiments, a first LED can emit red light, a second LED can emit green light, a third LED can emit blue light, and a fourth LED can emit yellow light, and a fifth LED can emit cyan light.

Different colors of light (e.g., red, green, blue) emitted by the LEDs 11a, 11b, and 11c may be mixed or homogenized in the mixing region 210 adjacent to the LEDs. Light emitted by the LEDs can enter through the edge of the mixing region 210 and light mixed or homogenized within the mixing region can enter an illumination panel 220 disposed adjacent to the mixing region 210. The illumination panel 220 may have an LCD layer (not shown) disposed thereover such that light emitted from the top surface (also referred to as the viewing region) of the illumination panel may illuminate the LCD layer.

FIG. 11B illustrates a top-view of an edge-lit LCD system 202 including LEDs and multiple heat pipes. LCD system 202 is similar to system 201 previously described except that system 202 includes a plurality of heat pipes each supporting one or more LEDs. In the illustrated embodiments, heat pipes 121a and 121b are arranged in a parallel configuration with each other and also with the illumination panel 220 sides. Heat pipe 121a supports LEDs 11aa, 11ba, and 11ca, and heat pipe 121b supports LEDs 11ab, 11bb, and 11cb. The operation of edge-lit LCD system 202 is similar to the operation of system 201, except that mixing region 210 receives light emitted by the LEDs on both heat pipes 121a and 121b, thereby increasing the amount of light that is transmitted into the illumination panel. It should be appreciated the heat pipes 121a and 121b may be thermally connected, for example, in a manner similar to that described in the thermal management system embodiments of FIGS. 5C and 5D.

In some embodiments, an edge-lit LCD system can include a plurality of modular panel members that can be arranged side-by-side so as to form an LCD system having a desired viewing area. An LCD arrangement formed from a series of adjacent modular members can enhance the scalability of the overall design, and can allow for the formation of any desired size LCD display.

FIG. 11C illustrates a top-view of an edge-lit LCD system including an illumination panel comprising a plurality of modular panel members 220a, 220b, and 220c. Each modular panel member may be disposed over the thermal management system (e.g., the one or more heat pipes 121) having one or more LEDs supported thereon. Furthermore, each modular panel member 220a, 220b, and 220c may also be respectively associated with a mixing region 210a, 210b, and 210c disposed between the LEDs 11 and each modular panel member. In the embodiment illustrated in FIG. 11C, the edge-lit LCD comprises a series of adjacent modular assemblies 202, 203, and 204, each including a plurality of heat pipes that each support one or more LEDs. In this particular illustrative embodiment, the modular assembly described is the edge-lit panel assembly illustrated in FIG. 11B, although it should be understood that any other assemblies may be used to construct the edge-lit LCD system. For example, each of the plurality of modular panel members may be disposed over one or more heat pipes (e.g., one heat pipe, two heat pipes, three heat pipes, four heat pipes).

In the illustrative embodiment, fin structure 125 is in thermal contact with the heat pipes 121 and may function as a heat sink. The fins structure 125 may be disposed underneath the modular panel members and the mixing regions, and can be incorporated as part of a tray (not shown) of the LCD system. The fin structure may be made, for example, of a substantially thermally conductive material such as aluminum and/or copper, and may have a structure and arrangement similar to that described in the fin structures of FIGS. 6A-6C or FIGS. 7A-7F.

It should be appreciated that although the illustrated embodiments of FIGS. 11A-11C show a thermal management system including heat pipes in certain arrangements, alternatively or additionally, any other type of thermal management system may be used, including other active and/or passive thermal management systems. Examples of some other possible thermal management systems that include heat pipes were described previously in relation to the embodiments illustrated in FIGS. 5A-5D.

It should be appreciated that LCD systems may include one or more of the features described, and various combinations of features may be desirable depending on the desired display system size and/or performance. In one embodiment, an LCD display system includes a thermal management system and at least one LED supported by the thermal management system. The LED and thermal management system are arranged so that the LED emits light in a direction parallel to the thermal management system. The LCD display can further include an illumination panel associated with the LED such that light emitted from the LED enters the illumination panel. The illumination panel can be substantially parallel with the thermal management system, and a LCD layer may be disposed over the illumination panel.

The LCD systems described herein may be ultra-thin having a thickness within the above-noted ranges (e.g., less than 10 mm, less than 4 mm, less than 2 mm, or even less than 1 mm.). Amongst other advantages, the efficient thermal management provided by the heat pipe assemblies may enables use of high power and/or brightness LEDs, as described above, without problems related to heat generation. The total number of LEDs used in the system may also be decreased because of their high power and/or brightness. Furthermore, the incorporation of the heat management system (e.g., heat pipe assemblies) can ensure that during operation of the LCD system, a substantially uniform temperature profile is achieved across a viewing region of the illumination panel of the LCD system. The uniform temperature profile can aid in the generation of light having similar brightness and/or color across the viewing region of the LCD system.

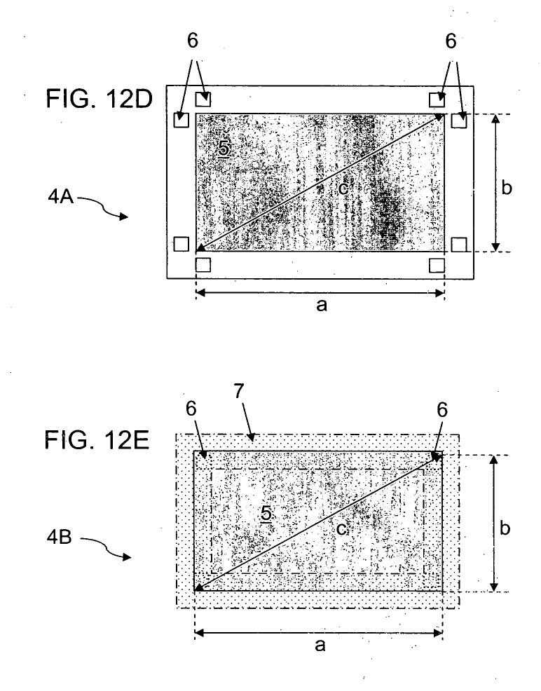

FIGS. 12A-12E show a variety of arrangements of LEDs associated with a display panel. In the embodiment illustrated in FIG. 12A, LCD system 1 includes LCD panel 5 having an illumination area defined by length a, height b, and diagonal c. The LCD can be edge-lit with LEDs positioned on one or more edges of the panel. For example, the LEDs can be positioned on a side edge, a bottom edge, a top edge, or a combination thereof. As shown in the embodiment illustrated in FIG. 12A, LEDs 6 are positioned on both the left and the right sides of the panel. As discussed in more detail below, the number of LEDs associated with a panel, as well as whether the LEDs are positioned on one, or more, edges of a panel, may depend on the size (e.g., area) of the illumination area.

Though the following description is directed to LCD panels, it should be understood that the numbers and dimensions provided below also relate to other optical systems such as illumination systems.

FIG. 12B shows another example of an edge-lit display system, where LEDs 6 are positioned on a bottom edge of the display panel. In other embodiments, LEDs can be positioned on a top edge of the display panel, or on both the top edge and the bottom edge of the display panel. Different numbers of LEDs can be positioned on an edge of a display panel in an edge-lit system, e.g., depending on the size and/or dimensions of the panel, as described in more detail below.

In the embodiment illustrated in FIG. 12C, LCD system 3 includes LEDs 6 positioned behind the LCD. In such a back-lit system, the LEDs illuminate an illumination area of the display from a rear of the LCD. Different numbers of LEDs can be positioned behind a display panel in a back-lit system, e.g., depending on the size and/or dimensions of the panel, as described in more detail below.

In other embodiments, LEDs 6 can be positioned on or near a corner of the display panel, for example, as shown in FIGS. 12D and 12E. In the embodiment illustrated in FIG. 12D, LEDs 6 are positioned outside of the illumination area of the display panel. In the embodiment illustrated in FIG. 12E, LEDs 6 are positioned at the corners inside the illumination area of the display panel. As shown, frame 7 can cover a portion of the illumination area. Different numbers of LEDs can be positioned on or near a corner of a display panel in a corner-lit system, e.g., depending on the size and/or dimensions of the panel, as described in more detail below.

As described above, the systems may be designed to use fewer LEDs than certain existing commercial displays. The systems may utilize the high-brightness LEDs described herein, in combination with the thermal management systems and other components described herein. For instance, in some embodiments, the number of LEDs illuminating a LCD panel may be fewer per unit area of the display panel. For example, the number of LEDs may be less than 300 LEDs per m² of the illumination area. In other embodiments, the number of LEDs illuminating a LCD panel is less than 200 LEDs per m², or less than 100 LEDs per m² of the illumination area. For example, the number of LEDs per m² of the illumination area may be between 5-100, between 25-100, or between 50-100. The number of LEDs per m² of the illumination area may depend on factors such as the illumination area and/or the dimensions of the illumination area. Such arrangements of LEDs are applicable to back-lit, edge-lit and corner-lit display systems.

In some embodiments, a single high-brightness LED can illuminate an entire illumination area of a LCD panel. The LCD panel may have an illumination area between 0.01 and 0.16 m², and the single LED associated with the LCD panel can illuminate a display having a diagonal between, e.g., 7 and 24 inches. For example, the single LED may illuminate a 7 inch panel, a 15 inch panel, a 17 inch panel, a 19 inch panel, or a 24 inch panel.

As used herein, a LCD system including a display panel having a certain diagonal of length c is referred to as an “c inch display”; the display panel is referred to as an “c inch panel”. Those of ordinary skill in the art know that display panels having a certain diagonal can have different areas depending on the dimensions of the panel. For example, displays may have different ratios of length-to-width, such as ratios of 16:9 and 4:3. Other ratios are also possible. Accordingly, a display panel having a 7 inch diagonal may have an illumination area of 0.01 m² for a 16:9 ratio, or an illumination area of 0.015 m² for a 4:3 ratio. A 15 inch display can have an illumination area of 0.062 m², corresponding to a 16:9 ratio, or an illumination area of 0.070 m², which corresponds to a 4:3 ratio. Those of ordinary skill in the art can calculate the illumination area of a display knowing the dimensions of the display and/or the diagonal and the ratio of the length-to-width of the display.

Another embodiment provides a LCD panel having an illumination area between 0.06 and 0.16 m² and at least one LED associated with the LCD panel such that light emitted from the at least one LED illuminates the LCD panel. The numbers of LEDs required to illuminate such a system may be, in some embodiments, an order of magnitude less than that in certain conventional systems. In some embodiments, the total number of LEDs in such a system is less than 50, less than 40, less than 30, or less than 20. For instance, the total number of LEDs may be between 5-50, between 25-50, and between 5-25. The LCD may have a diagonal between 15 and 24 inches; for example, the LCD may be a 15 inch display, a 17 inch display, a 19 inch display, or a 24 inch display.

Another embodiment provides a LCD panel having an illumination area between 0.16 and 0.6 m² and at least one LED associated with the LCD panel such that a light emitted from the at least one LED illuminates the LCD panel. In some embodiments, the total number of LEDs in such a system is less than 100, less than 75, less than 50, or less than 20. For instance, the total number of LEDs may be between 5-100, between 25-100, between 50-100, or between 75-100, between 2-50, or between 2-25. The LCD may have a diagonal between 24 and 46 inches; for example, the LCD may be a 24 inch display, a 32 inch display, a 42 inch display, or a 46 inch display.

In another embodiment, illumination of large-area displays is provided. High-brightness LEDs are especially suited for large-area displays, as these LEDs enable fewer numbers of LEDs to illuminate such a system, thereby simplifying the system design and lowering the cost of manufacture. The illumination area of a large-area display may be between, for example, 0.6 and 1.0 m². The LCD system may have a diagonal between 46 and 60 inches; for example, the LCD may be a 46 inch display, a 50 inch display, a 54 inch display, or a 60 inch display. In some embodiments, the total number of LEDs associated with such displays is less than 300, less than 200, or less than 100. For example, the total number of LEDs in such displays may be between 80-100, between 60-100, between 40-100, or between 20-100, or between 10-100. In another embodiment, a LCD panel having an illumination area greater than 0.5 m² may be illuminated by less than 300, less than 200, or less than 100 LEDs. For example, the total number of LEDs in such displays may be between 80-100, between 60-100, between 40-100, or between 20-100, or between 10-100.

Using high-brightness LEDs can allow the use of fewer numbers of LEDs for illumination while achieving a brightness comparable to, or exceeding, certain existing display systems of similar size. Accordingly, in certain embodiments, a display may have a brightness of at least 3,000 nits, at least 5,000 nits, at least 10,000 nits, at least 15,000 nits, at least 20,000 nits, or at least 25,000 nits.

It should be understood that for all of the display systems described above and herein, the display may be back-lit, edge-lit, corner-lit, or combinations thereof. Furthermore, those of ordinary skill in the art know that LCD systems, including those described above, can be used in monitors such as computer, laptop, and television monitors.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An optical system comprising:
a thermal management system;
at least one LED, wherein the at least one LED is supported by the thermal management system; and
an optical component associated with the LED such that light emitted from the LED enters the optical component.

2. The optical system of claim 1, wherein the LED is mounted on the thermal management system.

3. The optical system of claim 2, wherein the LED is mounted on the thermal management system with a thermally conductive attachment material.

4. The optical system of claim 1, wherein the LED is mounted on an interposer component, and wherein the interposer component is supported by the thermal management system.

5. The optical system of claim 4, wherein the LED is mounted on the interposer component with a thermally conductive attachment material.

6. The optical system of claim 1, wherein the thermal management system comprises at least one heat pipe.

7. The optical system of claim 6, wherein the at least one heat pipe is in thermal contact with at least one protrusion.

8. The optical system of claim 7, wherein the protrusion includes a textured surface.

9. The optical system of claim 8, wherein the textured surface comprises a dimpled surface.

10. The optical system of claim 6, wherein a contact of the LED is electrically connected with the at least one heat pipe.

11. The optical system of claim 6, wherein a contact of the LED is electrically connected to at least one contact supported by the at least one heat pipe.

12. The optical system of claim 6, wherein the at least one LED is supported by the at least one heat pipe.

13. The optical system of claim 6, wherein the at least one heat pipe comprises a plurality of heat pipes.

14. The optical system of claim 13, wherein the plurality of heat pipes form an array.

15. The optical system of claim 14, wherein some of the plurality of heat pipes at least partially overlie each other.

16. The optical system of claim 13, wherein at least some of the plurality of heat pipes are in thermal contact with at least one protrusion.

17. The optical system of claim 13, wherein at least some of the heat pipes have differing thermal conductances.

18. The optical system of claim 13, wherein at least some of the heat pipes are in thermal contact with each other.

19. The optical system of claim 18, wherein the thermal contact is achieved via an attachment material between the heat pipes in contact with each other.

20. The optical system of claim 18, wherein the heat pipes are disposed under a portion of the optical component.

21. The optical system of claim 13, wherein the at least one LED comprises a first LED and a second LED.

22. The optical system of claim 21, wherein the first LED is supported by a first heat pipe of the plurality of heat pipes, and the second LED is supported by a second heat pipe of the plurality of heat pipes.

23. The optical system of claim 1, wherein the optical system comprises a red LED, a blue LED, and a green LED.

24. The optical system of claim 23, wherein the red LED, the blue LED, and green LED are mounted on a single package.

25. The optical system of claim 1, wherein the thermal management system is arranged such that a substantially uniform temperature profile is achieved across a viewing region of the optical component during operation of the optical system.

26. The optical system of claim 1, wherein the thermal management system comprises an active thermal management system.

27. The optical system of claim 1, wherein the thermal management system comprises a passive thermal management system.

28. The optical system of claim 1, wherein the optical system is substantially flat.

29. The optical system of claim 1, wherein the optical component comprises a plurality of modular panel members.

30. The optical system of claim 29, wherein at least one of the plurality of modular panel members is coupled to the at least one LED.

31. The optical system of claim 30, wherein the at least one LED comprises a red LED, a blue LED, and a green LED.

32. The optical system of claim 30, wherein the at least one of the plurality of modular panel members is in thermal contact with the thermal management system.

33. The optical system of claim 1, wherein the thermal management system is substantially parallel with the optical component.

34. The optical system of claim 1, wherein the LED comprises a photonic lattice structure.

35. The optical system of claim 1, further comprising a mixing region arranged such that light emitted from the LED enters the mixing region and light emitted from the mixing region enters the optical component through at least one edge of the optical component.

36. The optical system of claim 1, wherein the optical system has a thickness of less than 30 mm.

37. The optical system of claim 1, wherein the thermal management system dissipates at least 5 W.

38. The optical system of claim 1, wherein the LED emits light having a power of at least 0.5 Watts.

39. The optical system of claim 1, further comprising a temperature sensor measuring temperature that is representative of a temperature of the optical component.

40. The optical system of claim 39, further comprising a control system that receives an input signal representative of the temperature sensor measurement, and outputs a signal that controls in part light emission from the LED.

41. The optical system of claim 40, wherein the LED is mounted on the thermal management system with a thermally conductive attachment material

42. The optical system of claim 1, wherein the optical component comprises an illumination panel.

43. The optical system of claim 42, wherein the illumination panel is substantially flat.

44. The optical system of claim 1, wherein the optical component comprises a cylindrically-shaped component.

45. The optical system of claim 1, wherein the optical system serves as a display.

46. The optical system of claim 1, wherein the optical system serves as an illumination system.

47. An optical system comprising:
a thermal management system;
at least one LED, wherein the at least one LED is supported by the thermal management system; and
an optical component associated with the LED such that light emitted from the LED enters the optical component through an edge of the optical component.

48. The optical system of claim 47, wherein the LED is mounted on the thermal management system.

49. The optical system of claim 47, wherein the LED is mounted on an interposer component, and wherein the interposer component is supported by the thermal management system.

50. The optical system of claim 47, wherein the thermal management system comprises at least one heat pipe.

51. The optical system of claim 50, wherein the at least one heat pipe is in thermal contact with at least one protrusion.

52. The optical system of claim 50, wherein the at least one heat pipe comprises a plurality of heat pipes.

53. The optical system of claim 47, wherein the optical system comprises a red LED, a blue LED, and a green LED.

54. The optical system of claim 47, wherein the thermal management system comprises an active thermal management system.

55. The optical system of claim 47, wherein the thermal management system comprises a passive thermal management system.

56. The optical system of claim 47, wherein the thermal management system is substantially parallel with the optical component.

57. The optical system of claim 47, wherein the LED comprises a photonic lattice structure.

58. The optical system of claim 47, further comprising a mixing region arranged such that light emitted from the LED enters the mixing region and light emitted from the mixing region enters the optical component.

59. The optical system of claim 47, wherein the optical component comprises an illumination panel.

60. The optical system of claim 59, wherein the illumination panel is substantially flat.

61. The optical system of claim 47, wherein the optical component comprises a cylindrically-shaped component.

62. The optical system of claim 47, wherein the optical system serves as a display.

63. The optical system of claim 47, wherein the optical system serves as an illumination system.

64. A method of forming an optical system, the method comprising:
supporting an LED on a thermal management system such that the LED emits light in a direction parallel to the thermal management system; and
associating an optical component with the LED and the thermal management system such that light emitted from the LED enters the optical component through an edge.
